(19) United States
(12) Patent Application Publication
(10) Pub. No.: US 2007/0193416 A1
(43) Pub. Date: Aug. 23, 2007

(54) Locking speed driver

(76) Inventor: James P. Frankewich, Colorado Springs, CO (US)

Correspondence Address: LOCKE LIDDELL & SAPP LLP;ATTN: IP DOCKETING, 600 TRAVIS STREET, 3400 CHASE TOWER, HOUSTON, TX, 77002, US

(21) Appl. No.: 11/360,832

(22) Filed: Feb. 23, 2006

(51) Int. Cl. B25G 3/02

(52) U.S. Cl. 81/28

(57) ABSTRACT

The present disclosure provides an improved system and method of using a speed driver with a shank that can be selectively locked to the handle. Such locking can occur without significant effort or even removing the driver from the fastener during operation. The shank is biased in a first position with the handle for independent rotation in the handle, and selectively engaged with the handle in a second position with the handle. Thus, a speed driver can still offer the relatively rapid rotation from cranking the handle about the shank, yet selectively provide high torque similar to a fixed handle/shank arrangement in a typical screwdriver or other driver.

### CROSS REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO APPENDIX

Not applicable.

### BACKGROUND

1. Field of the Invention

The invention relates to hand tools. More specifically, the invention relates to drivers for fasteners.

2. Description of Related Art

There are many times when a great degree of torque is needed to use a driver such as a nutdriver or screwdriver, to turn a screw, nut or other fastener. Typically, a larger driver is used with a larger handle for the greater torque. If the torque is too much for the driver, a wrench is often located and separately applied if possible. At other times, little torque is required and the fastener can be quickly turned with minimum torque.

A hybrid driver, sometimes termed a “speed driver,” combines the handle of a typical screwdriver design with an offset shank, where the handle can freely rotate around the shank. To operate, the handle is grasped and “cranked” around the shank engaged with the fastener, similar to a crank on a brace and bit drill assembly or an old-fashioned home ice cream maker. The cranking action rotates the shank to turn the fastener. However, such speed drivers are known for having typically little torque capabilities, because the offset distance is typically small due to other considerations such as storage and practical uses, and the handle freely rotates around the shank. Thus, another driver, such as a screwdriver, is generally used to exert the higher torque requirements by twisting the driver handle. Such a torque limitation on speed drivers counters the speed advantage by causing the user to carry two drivers and switch between the drivers during the loosening or tightening of the fastener.

Thus, there remains a need to provide speed drivers with increased torque capabilities.

### BRIEF SUMMARY

The present disclosure provides an improved system and method of using a speed driver with a shank that can be selectively locked to the handle. Such locking can occur without significant effort or even needing to remove the driver from the fastener during operation. The shank is biased in a first position for independent rotation in the handle, and in a second position selectively engaged with the handle. Thus, a locking speed driver can still offer the relatively rapid rotation from cranking the handle about the shank, yet selectively provide high torque similar to a fixed handle/shank arrangement in a typical screwdriver or other driver.

The disclosure provides a driver for turning an object, comprising: a handle having a cavity formed in the handle; a shank having a rotational portion coupled to the handle, an engagement portion having one or more torque elements, an offset portion, and a tip portion, the offset portion establishing an offset distance between the rotational portion and tip portion; and the handle and shank being rotationally decoupled and longitudinally coupled in a first mode and rotationally coupled and longitudinally coupled in a second mode through selective engagement of the torque elements in the engagement portion of the shank with the handle.

The disclosure further provides a method for turning an object with a speed driver having a handle with a cavity formed therein, a shank longitudinally coupled to the handle, the shank having an offset portion establishing an offset distance between a portion of the shank coupled to the handle and a tip portion of the shank, the method comprising: engaging the object with the tip portion; cranking the handle radially around the tip portion of the shank at the offset distance to rotate the tip portion and the object engaged with the tip portion, the shank being rotationally decoupled from the handle; rotationally coupling the shank with the handle; and twisting the handle to twist the shank to turn the object.

### BRIEF DESCRIPTION OF THE DRAWINGS

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art as required by 35 U.S.C. §112.

FIG. 1 is a schematic cross-sectional longitudinal view of the locking speed driver of the present disclosure.

FIG. 2 is a schematic transverse cross sectional view at section 2 of the locking speed driver of FIG. 1.

FIG. 3 is a schematic cross-sectional longitudinal view of the locking speed driver with the shank locked with the handle.

### DETAILED DESCRIPTION

One or more illustrative embodiments incorporating the invention disclosed herein are presented below. Not all features of an actual implementation are described or shown in this application for the sake of clarity. It is understood that the development of an actual embodiment incorporating the present invention, numerous implementation-specific decisions must be made to achieve the developer's goals, such as compliance with system-related, business-related and other constraints, which vary by implementation and from time to time. While a developer's efforts might be complex and time-consuming, such efforts would be, nevertheless, a routine undertaking for those of ordinary skill in the art having benefit of this disclosure.

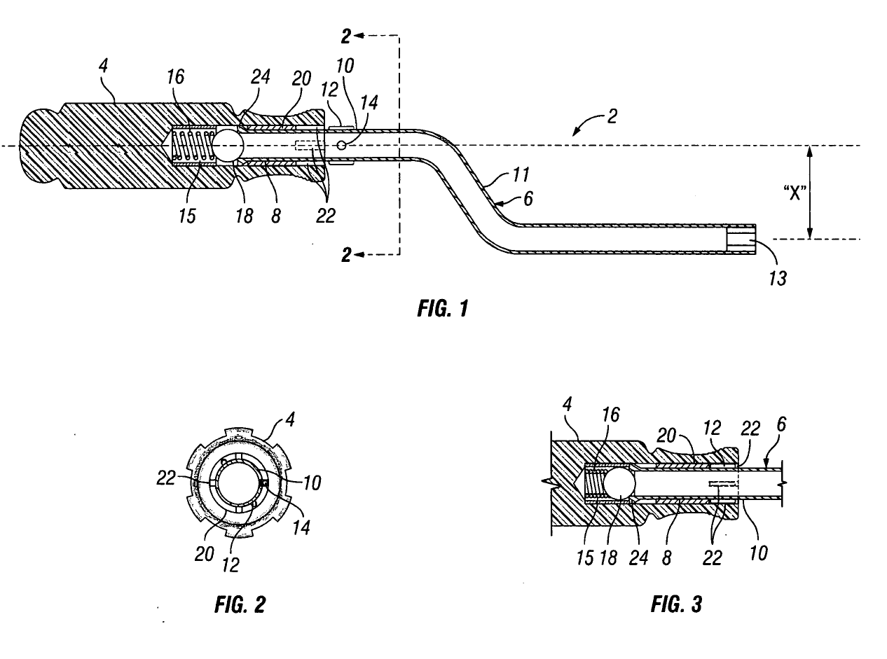

FIG. 1 is a schematic cross-sectional longitudinal view of an exemplary locking speed driver of the present disclosure. The locking speed driver generally includes a handle 4, and a shank 6 rotatably decoupled to the handle in a first mode, and rotatably coupled to the handle in a second mode. The handle 4 can be a handle as would be generally used in the industry as may be appropriate, such as a screwdriver handle or other shaped handle. In general, the handle 4 will allow an operator by one hand to conveniently rotate or “crank” the handle about the axis of the shank 6. The shank 6 generally includes a tubular or solid member that can be of a variety of cross sectional geometric shapes. Without limitation, the shank can be circular, rectangular, hexagonal, elliptical, and other geometric shapes.

The shank can further be divided into portions depending on their function. The rotational portion 8 of the shank 6 can be disposed within the handle 4 and generally is sized to be retained within a cavity 15 of the handle. An engagement portion 10 is distal from the handle 4 relative to the rotational portion 8. The engagement portion 10 generally includes a torque element 12. In at least one embodiment, the torque element can include a wing, or other protrusion extending in one or more directions from the periphery of the shank 6 and the engagement portion 10. The shank further includes an offset portion 11 distal from the engagement portion 10 relative to the handle 4. The offset portion allows the speed driver to function by being offset a distance “X” from an end of the shank engaged with the fastener to the rotational portion 8 of the handle 4. The length of “X” depends on the desired offset torque to be exerted by the locking speed driver through a tip portion 13 in at least a first mode shown in FIG. 1.

The shank 6 further includes a tip portion 13. The tip portion can either have a fixed blade or other engagement tip (not shown) for engaging a fastener to rotate the fastener. While a fastener is generally contemplated as being turned by the locking speed driver herein, any object that can be turned by a driver is included within the scope of this disclosure and within a broad definition of a “fastener” herein. Alternatively, the tip portion 13 can also include a universal shape known to those with ordinary skill in the art to receive such standard tips, such as hexagonal screwdriver tips of different shapes, nut drivers, socket drivers, and other standard attachments. The tip portion can also be provided with a magnet to assist in holding the tips and fastener.

Describing the handle in more detail, the handle 4 generally includes a cavity 15 formed in an end-portion of the handle facing the shank 6. The cavity 15 can include a bias element 16, such as a compressive coil spring or other bias element, to bias the shank outwardly from the handle 4. A frictional element 18, such as a ball bearing, can be also disposed in the cavity to act as a rotational surface transitioning between the spring 16 and the rotational portion 8 of the shank 6. The rotational portion 8 is generally inserted within the cavity 15 and can engage the frictional element 18.

A locking insert 20 can be inserted distal from the bias element 16 in the cavity 15 toward the shank 6. The locking insert 20 generally includes one or more receivers 22 that can receive the torque element 12 of the engagement portion 10 of the shank. As one example and without limitation, the receiver 22 can include a longitudinal slot and the torque element can include a longitudinal wing sized to be received within the receiver 22. While the figures and disclosures generally reference one or more receivers on the locking insert and one or more torque elements on the shank, it would be understood by those with ordinary skill in the art, that the locking insert could include the torque elements, and the shank could include the receivers, or other similar combinations.

In at least one embodiment, the locking insert 20 can be sized to be press fitted within the cavity 15 and fixedly coupled to the handle 4. A cross sectional area of the locking insert 20 can be sized to receive the rotational portion 8 in a rotational and sliding fit. In at least one embodiment, the rotational portion 8 can be retained within the handle 4 by a flange 24 formed on a periphery surface of the rotational portion 8 inside the cavity 15), where the flange 24 is larger in cross sectional dimension than the inner cross sectional dimension of the lock insert 20. Thus, the spring 16 can bias the frictional element 18 and the rotational portion 8 of the shank 6 toward the locking insert 20, but the flange 24 is sized to not pass through the locking insert 20, thus retaining the rotational portion 8 within the handle 4. A shank retainer 14, such as a spring loaded ball, can be used in some embodiments to help retain the engagement portion 10 within the locking insert 20 when so situated.

FIG. 2 is a schematic transverse cross sectional view at section 2 of the locking speed driver, shown in FIG. 1. The handle 4 generally includes the locking insert 20 coupled thereto. The locking insert 20 can include one or more receivers 22 sized and adapted to fit and be engaged by a torque element 12, such as a longitudinal wing, flange, or other protrusion. The shank includes the engagement portion 10 having the torque element 12 that can be selectably slidably and rotatably coupled to the handle 4, shown in FIG. 1.

FIG. 3 is a schematic cross-sectional longitudinal view of the locking speed driver with the shank rotatably coupled with the handle. The handle 4 generally includes the cavity 15 having the bias element 16 inserted therein with a frictional element 18 disposed generally between the bias element 16 and the rotational portion 8 of the shank 6. The engagement portion 10 is shown with the torque element 12 engaged with the receiver 22 of the locking insert 20. The locking insert 20 restricts the outward movement of the flange 24 and thus retains the shank 6 within the cavity 15 of the handle 4.

The shank is longitudinally coupled to the handle during assembly of the speed driver and remains longitudinally coupled during different modes of operation. Specifically, in a first mode, the shank is longitudinally coupled to the handle while being rotationally decoupled from the handle. In a second mode, the shank is longitudinally coupled and rotationally coupled to the handle. In the first mode, the handle can be cranked around the shank at the offset distance “X” relative to the tip portion so that the shank is rotated independent of the handle rotation, that is, twisting the handle about its axis does not necessarily twist the shank. In the second mode, the handle is rotationally coupled to the shank so that the rotation of the shank and handle are dependent upon each other. In the second mode, the handle can be twisted so that the shank twists. For example, the twisting can occur at an initial loosening of a fastener or a final tightening of the fastener, where such loosening and tightening generally has increased torque capabilities.

In operation, the speed driver can turn a fastener by engaging the fastener or other object with the tip portion, cranking the handle radial around the tip portion of the shank at the offset distance “X” to rotate the tip portion and the object engaged with the tip portion, where the shank is rotationally decoupled from the handle in the first mode. For increased torque, the handle can be pressed longitudinally toward the shank to push the shank into the cavity and engage the torque element on the shank with the handle so that the handle and shank are rotationally coupled. The handle can then be twisted which in turn twists the shank to turn the object.

More specifically, FIG. 1 illustrates the first mode in which the handle 4 is rotationally decoupled from the torque element 12 and allowed to rotate relative to the shank 6. FIG. 3 illustrates the second mode in which the handle is rotationally coupled with the shank 6 by engagement of the torque element 12 with the receiver 22, when the bias element is compressed. An operator can grasp the handle 4 and insert an appropriate tip (not shown) into the tip portion 13, if a tip is not already provided. The operator can then engage a fastener with the tip portion 13, grasp the handle, and crank the handle around the tip portion 13 at a radius X. For increased torque, the operator can push the handle 4 toward the shank 6, in particular the engagement portion 10, and align the receiver 22 with the torque element 12 by rotation of the handle 4 relative to the shank 6 as needed. When the receiver 22 and torque element 12 are aligned, the handle is further pushed toward the engagement portion 10, thereby compressing the spring 16 until the torque element 12 is longitudinally received within the receiver 22. At that point, the handle is then rotationally coupled, that is fixedly coupled, with the shank 6. The operator can then twist the handle 4 to exert further torque on the tip portion 13 and the fastener (not shown) to which the tip portion is engaged.

To disengage the torque element 12 from the receiver 22, the operator can simply reduce or relax the longitudinal pressure on the bias element 16 to allow the handle to move away from the shank 6 and particularly the engagement portion 10. The handle then is rotationally decoupled from the shank 6 and allowed to rotate or “crank” around the shank 6 as before. The retainer 14 can assist in retaining the torque element 12 with the receiver 22 by applying radially outward pressure to the receiver 22 or other portion of the handle 4 during the rotational coupling of the handle with the shank 6. However, such outward pressure generally does not exceed the longitudinal force of the spring 16 to allow disengagement of the handle from the engagement portion 10 of the shank 6.

The invention has been described in the context of preferred and other embodiments and not every embodiment of the invention has been described. Apparent modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

The term “coupled,” “coupling,” “coupler,” and like terms are used broadly herein and can include any method or device for securing, fastening, attaching, joining, inserting therein, forming thereon or therein, communicating, or otherwise associating, directly or indirectly with intermediate elements, one or more members together and can further include without limitation integrally forming one functional member with another in a unity fashion. The coupling can occur in any direction, including rotationally.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant(s).

1. A driver for turning an object, comprising:
a handle having a cavity formed in the handle;
a shank having a rotational portion coupled to the handle, an engagement portion having one or more torque elements, an offset portion, and a tip portion, the offset portion establishing an offset distance between the rotational portion and tip portion; and
the handle and shank being rotationally decoupled and longitudinally coupled in a first mode and rotationally coupled and longitudinally coupled in a second mode through selective engagement of the torque elements in the engagement portion of the shank with the handle.

2. The driver of claim 1, further comprising a bias element disposed in the handle cavity and adapted to bias the rotational portion of the shank away from the handle so that the shank portion is decoupled from the handle.

3. The driver of claim 1, further comprising a frictional element disposed in the cavity between the bias element and rotational portion of the shank about which the rotational portion is adapted to rotate.

4. The driver of claim 1, wherein the handle comprises one or more receivers adapted to receive the torque elements of the shank engagement portion.

5. The driver of claim 4, wherein the one or more torque elements comprises one or more projections extending radially outward from the shank and the one or more receivers comprises one or more slots adapted to fit the projections when selectively engaged.

6. The driver of claim 1, further comprising a locking insert adapted to be inserted into the handle cavity and be rotationally coupled to the handle, the locking insert having one or more receivers adapted to receive the torque elements of the shank engagement portion.

7. The driver of claim 6, wherein the rotational portion of the shank further comprising a flange having a larger cross sectional dimension than an inner cross sectional dimension of the locking insert, the flange being disposed longitudinally in the cavity so that the flange is retained in the cavity by the locking insert.

8. A method for turning an object with a speed driver having a handle with a cavity formed therein, a shank longitudinally coupled to the handle, the shank having an offset portion establishing an offset distance between a portion of the shank coupled to the handle and a tip portion of the shank, the method comprising:
engaging the object with the tip portion;
cranking the handle radially around the tip portion of the shank at the offset distance to rotate the tip portion and the object engaged with the tip portion, the shank being rotationally decoupled from the handle;
rotationally coupling the shank with the handle; and
twisting the handle to twist the shank to turn the object.

9. The method of claim 8, wherein rotationally coupling the shank to the handle comprises pressing the handle longitudinally toward the shank to push the shank into the cavity and engaging a torque element on the shank, the handle, or a combination thereof.

10. The method of claim 9, wherein engaging the torque element comprises engaging a protrusion extending radially outward from the shank with a slotted receiver fixedly mounted to the handle and sized to receive the protrusion.

11. The method of claim 8, wherein rotationally coupling the shank to the handle comprises initially loosening the fastener, finally tightening the fastener, or a combination thereof.

12. The method of claim 8, further comprising maintaining the longitudinally coupling the shank to the handle when the handle is both rotational decoupled and rotationally coupled with the shank.

13. The method of claim 8, further comprising biasing the shank to be rotationally decoupled from the handle.

14. The method of claim 8, further comprising releasing the rotationally coupling of the shank to the handle while maintaining the longitudinal coupling of the shank with the handle.
